(19) United States
(12) Patent Application Publication
(10) Pub. No.: US 2011/0301999 A1
(43) Pub. Date: Dec. 8, 2011

(54) PROJECT SUPPORTING METHOD, EXECUTION PROGRAM THEREFOR, AND EXECUTION DEVICE THEREFOR

(76) Inventors: Takaharu Matsui, Hayama (JP); Akira Tada, Kawasaki (JP)

(21) Appl. No.: 13/146,232

(22) PCT Filed: Nov. 19, 2009
(86) PCT No.: PCT/JP2009/069611

§ 371 Date: Aug. 24, 2011

(30) Foreign Application Priority Data
Feb. 17, 2009 (JP) 2009-033768

(51) Int. Cl. G06Q 10/00

(52) U.S. Cl. 705/7.28

(57) ABSTRACT

Data to support a determination as to whether or not a project can be executed, etc., is provided on the basis of a cost estimation value of project deliverables. Regarding a risk event parameter group which is a collection of risk event parameters indicating a degree of estimation risk for each of a plurality of estimation risk events, the similarity between risk event parameter groups of a plurality of past projects and a risk target parameter group of a target project is obtained (S41 to S43), the top N past projects in terms of the similarity to the target project is extracted from the plurality of past projects (S43), a cost deviation of a cost estimation value of the target project is obtained from the cost estimation value and the actual value of each of the N past projects (S45, S46), cost fluctuation information is created on the basis of the cost deviation of the target project (S47), and the cost fluctuation information is displayed.

### TECHNICAL FIELD

The present invention relates to a technique of supporting a project on the basis of estimates of earnings parameters such as costs of development and manufacturing, sales volume, profit and loss and the like concerning earnings from deliverables of the project.

### BACKGROUND ART

At a starting-up or initial stage of a project that involves a sequence of development and selling of a product, a manufacturer usually estimates costs of development and manufacturing of the product, volume of sales of the product, and the like in order to decide the advisability of execution of the project or determine a budget for execution of the project. Thus, more accurate estimates of costs and the like are desirable when such estimates are required for making a decision to permit or reject execution of a project.

As an example of a conventional technique of estimating costs and the like concerning deliverables of a project, the following Patent Document 1 discloses a technique in which various kinds of productivity indexes are calculated on the basis of results data of past projects, and costs and the like are estimated accurately by using those various kinds of productivity indexes.
Patent Document 1: Japanese Published Unexamined Patent Application No. 2005-259000

As described above, it is required to estimate costs and the like concerning earnings from deliverables of a project as accurately as possible in order to make a decision to permit or reject execution of the project or determine a budget for execution of the project, for example. However, it is usual that many estimation risk events such as unknown matters, indefinite matters and the like exist at an estimation stage. Thus, it is very difficult to estimate costs and the like accurately. And, estimates according to the technique described in Patent Document 1 are insufficient by themselves as data for deciding the advisability of a project or for determining a budget for a project.

Noticing these problems, an object of the present invention is to provide a technique of supporting a project by providing data that are effective for such purposes as deciding the advisability of a project and determining a budget for a project.

### DISCLOSURE OF THE INVENTION

According to the present invention, a computer executes the following steps (1)-(6) to solve the above problems.

(1) A past data receiving step, in which an input means of the computer receives an estimate and an actual value of the earnings parameter concerning the earnings from the deliverables of each of a plurality of past project, and a risk event parameter group i.e. a set of risk event parameters indicating respectively degrees of estimation risks of a plurality of estimation risk events of the past project in question;
(2) A target data receiving step, in which the input means receives the estimate of the earnings parameter concerning the target project, and a risk event parameter group i.e. a set of risk event parameters indicating respectively degrees of estimation risks of the plurality of estimation risk events concerning the target project;
(3) A similarity calculation step, in which, for each of the plurality of past projects, a degree of similarity between the risk event parameter group of the past project in question and the risk object parameter group of the target project is obtained;
(4) An extraction step, in which top one or more past projects having highest degrees of similarities with the target project among the plurality of past projects are extracted according to previously-determined rule;
(5) A fluctuation information generation step, in which earnings fluctuation information concerning fluctuation of the earnings parameter with reference to the estimate of the target project is generated on a basis of the estimate and actual value of the earnings parameter of each of the one or more past projects extracted in the extraction step; and
(6) An information output step, in which an output means of the computer outputs the earnings fluctuation information.

Further, according to the present invention, it is favorable that the computer executes the following steps (7)-(13).

(7) A posterior-to-countermeasure parameter setting step, in which risk event parameters in the risk event parameter group of the target project are changed in such a direction that degrees of risks become smaller on the assumption of execution of risk countermeasures, to obtain a plurality of posterior-to-countermeasure risk event parameter groups;
(8) A posterior-to-countermeasure similarity calculation step, in which, for each of the plurality of past projects, a degree of similarity between a risk event parameter group of the past project in question and one of the posterior-to-countermeasure risk event parameter groups of the target project is obtained;
(9) A posterior-to-countermeasure extraction step, in which top one or more past projects having highest degrees of similarities with the one of the posterior-to-countermeasure risk parameter groups of the target project are extracted according to a previously-determined rule, among the plurality of past projects;
(10) A provisional fluctuation information generation step, in which provisional earnings fluctuation information concerning fluctuation of the earnings parameter with reference to the estimate of the target project is generated on a basis of the estimate and actual value of the earnings parameter of each of the one or more past projects extracted in the posterior-to-countermeasure extraction step;
(11) A processing control step, in which the posterior-to-countermeasure similarity calculation step, the posterior-to-countermeasure extraction step, and the provisional fluctuation information generation step are executed with respect to all the posterior-to-countermeasure risk event parameter groups obtained in the posterior-to-countermeasure parameter setting step;
(12) A posterior-to-countermeasure fluctuation information generation step, in which statistical processing of the provisional earnings fluctuation information is performed for each of all the posterior-to-countermeasure risk event parameter groups obtained in the posterior-to-countermeasure parameter setting step, to generate posterior-to-countermeasure earnings fluctuation information concerning fluctuation of the earnings parameter with reference to the estimate of the target project; and
(13) A posterior-to-countermeasure information output step, in which the output means is made to output the posterior-to-countermeasure earnings fluctuation information.

The present invention indicates earnings fluctuation information with reference to an estimate of an earnings parameter concerning a target project, and thus it is possible to support judgment on the advisability of execution of the target project, determination of a budget for the target project, or the like.

### BRIEF DESCRIPTION OF DRAWINGS

FIG. 1 is a block diagram showing a project support apparatus according to an embodiment of the present invention;

FIG. 2 is an explanatory diagram showing a data structure of a risk event content table according to an embodiment of the present invention;

FIG. 3 is an explanatory diagram showing a data structure of an earnings data table of a target project according to an embodiment of the present invention;

FIG. 4 is an explanatory diagram showing a data structure of a risk event parameter table of a target project according to an embodiment of the present invention;

FIG. 5 is an explanatory diagram showing a data structure of a past project earnings data table according to an embodiment of the present invention;

FIG. 6 is an explanatory diagram showing a data structure of a past project risk event parameter table according to an embodiment of the present invention;

FIG. 7 is an explanatory diagram showing a data structure of a prior-to-countermeasure project similarity table according to an embodiment of the present invention;

FIG. 8 is an explanatory diagram showing a data structure of a posterior-to-countermeasure project similarity table according to an embodiment of the present invention;

FIG. 9 is a flowchart showing operation of a project support apparatus according to an embodiment of the present invention;

FIG. 10 is a flowchart showing detailed processing in the step 40 of the flowchart of FIG. 9;

FIG. 11 is a flowchart showing detailed processing in the step 50 of the flowchart of FIG. 9;

FIG. 12 is a flowchart (first part) showing detailed processing in the step 70 of the flowchart of FIG. 9;

FIG. 13 is a flowchart (second part) showing a detailed processing in the step 70 of the flowchart of FIG. 9;

FIG. 14 is an explanatory view showing an example of an input screen according to an embodiment of the present invention; and

FIG. 15 is an explanatory view showing an example of an output screen according to an embodiment of the present invention.

### BEST MODE FOR CARRYING OUT THE INVENTION

Now, an embodiment of a project support apparatus according to the present invention will be described referring to the drawings.

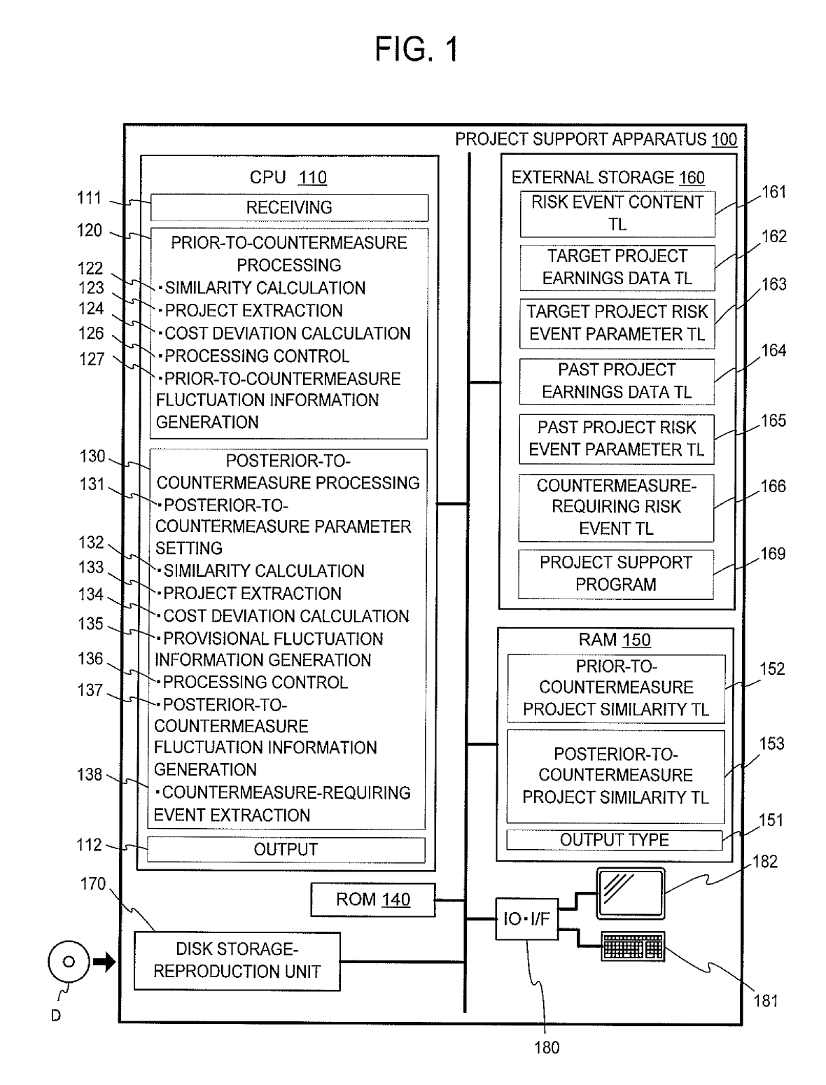

The project support apparatus of the present embodiment is an apparatus for outputting earnings fluctuation information that is a kind of earnings parameter and shows fluctuation of a development-manufacturing cost with reference to an estimate of the development-manufacturing cost. As shown in FIG. 1, the project support apparatus 100 is a computer and comprises: a CPU 110 for executing various operations; a ROM 140, which previously stores various types of data, programs and the like; a RAM 150, which becomes a work area for the CPU 110; an external storage 160 such as a hard disk drive or the like; a disk storage-reproduction unit 170 for storing and reproducing data to and from a disk-type storage medium; a input unit 181 such as a keyboard and/or a mouse; a display unit 182; an input-output interface 180 for the input unit 181 and the display unit 182; and a communication unit not shown in the figure.

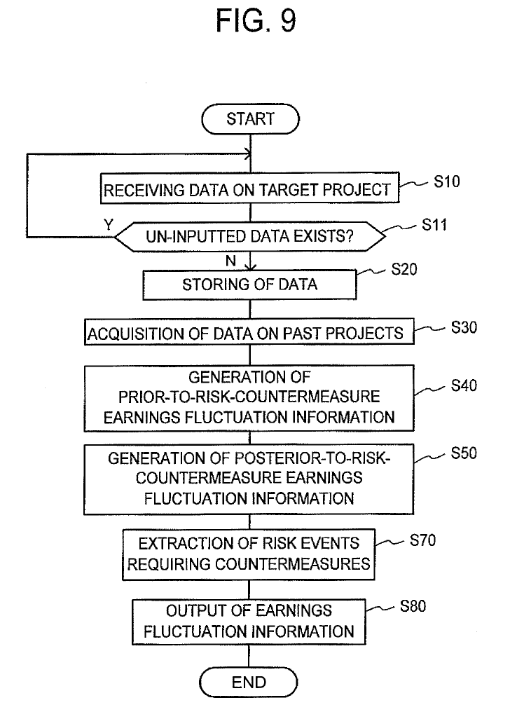

The external storage 160 stores: a risk event content table 161 for storing contents and IDs of a plurality of estimation risk events such as matters that are unknown or indefinite at the estimation stage; an earnings data table 162 for storing various earnings data on a project as the target of support; a risk event parameter table 163 for storing risk event parameters that indicate degrees of risks of a plurality of estimation risk events respectively concerning the target project (hereinafter, a set of risk event parameters is referred to as a risk event parameter group); an earnings data table 164 for storing various earnings data on a plurality of past projects; a risk event parameter table 165 for storing risk event parameter groups for each of the plurality of past projects; and a countermeasure-requiring event table 165 for storing IDs and the like of risk event parameters that are different from the corresponding risk event parameters in a posterior-to-risk-countermeasure risk event parameter group used for generating the above-mentioned earnings fluctuation information, among the risk event parameters of the risk event parameter group before taking the countermeasures against the risks. Among these tables 161-166, the tables 162-166 except for the risk event content table 161 store data, in the course of processing that will be described referring to the flowcharts of FIGS. 9-13.

The external storage 160 further stores a project support program 169 to be executed by the CPU 110. The project support program 169 may be obtained by reproduction from a disk D storing the program 169 through the disk storage-reproduction unit 170, or may be obtained through the communication unit not shown in the figure.

Here, all the tables 161-166 are stored in the external storage 160. However, these tables may be stored in another storage unit. In particular, the earnings data table 162 on a target project, the risk event table 163 on the target project and the countermeasure-requiring risk event table 166 may be stored in the RAM 150.

In the RAM 150, there will be placed: a prior-to-countermeasure project similarity table 152 for storing the degrees of similarities between a risk event parameter group at a stage before taking countermeasures against the estimation risks of the target project and estimation risk event parameter groups of the plurality of past projects; and a posterior-to-countermeasure project similarity table 153 for storing the degrees of similarities between a risk event parameter group that is assumed taking countermeasures against the estimation risk events of the target project and the risk event parameter groups of the plurality of past projects. These tables 152 and 153 are prepared in the RAM 150 in the course of processing that will be described referring to the flowcharts of FIGS. 9-13.

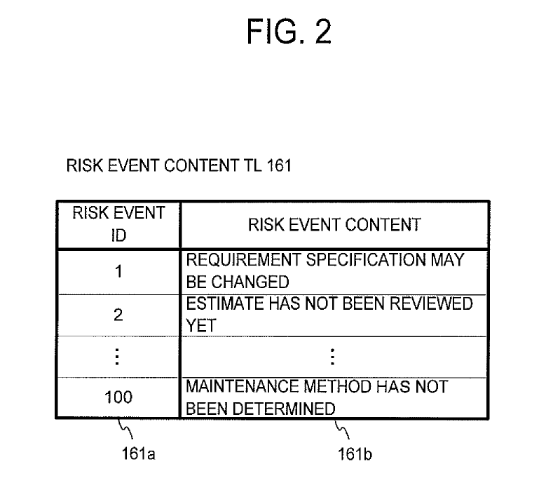

As shown in FIG. 2, the risk event content table 161 in the external storage 160 has a risk event ID area 161a for storing a risk event ID and a risk event content area 161a for storing the content of the risk event corresponding to the risk event ID. This risk event table 161 stores data in the areas 161a and 161b in advance of inputting various data.

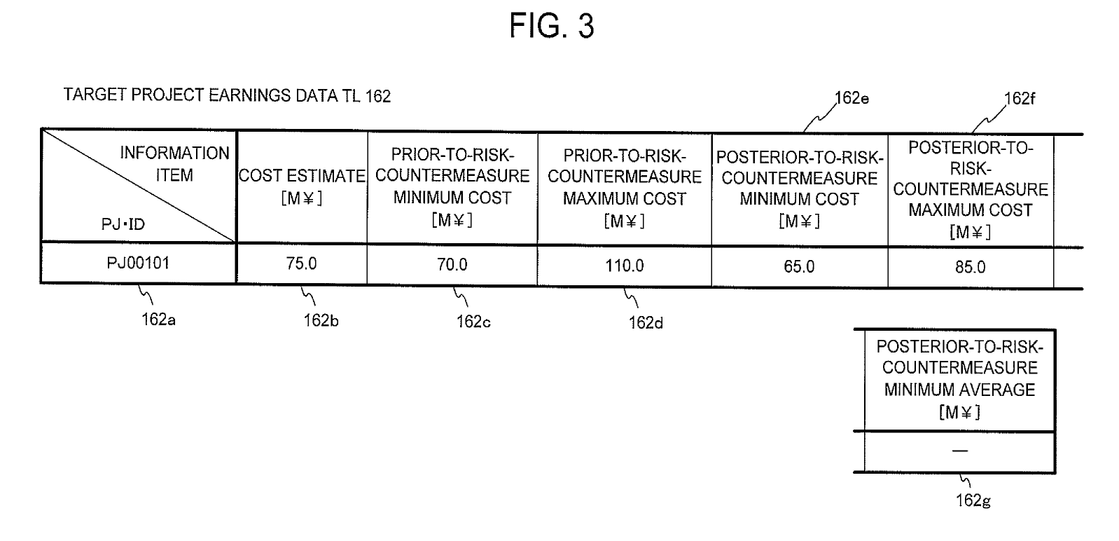

As shown in FIG. 3, the target project earnings data table 162 has a project ID area 162a for storing a target project ID, a cost estimate area 162b for storing a cost estimate of the target project, a prior-to-risk-countermeasure minimum cost area 162c for storing the minimum value of cost before taking the risk countermeasure for the target project, a prior-to-risk-countermeasure maximum cost area 162d for storing the maximum value of cost before taking the risk countermeasure for the target project, a posterior-to-risk-countermeasure minimum cost area 162e for storing the minimum value of cost after taking the risk countermeasure for the target project, a posterior-to-risk-countermeasure maximum cost area 162f for storing the maximum value of cost after taking the risk countermeasure for the target project, and a posterior-to-risk-countermeasure minimum average cost area 162g for storing the minimum value among average values of cost after taking the risk countermeasure for the target project. The “minimum value among average values of cost” mentioned above will be described later.

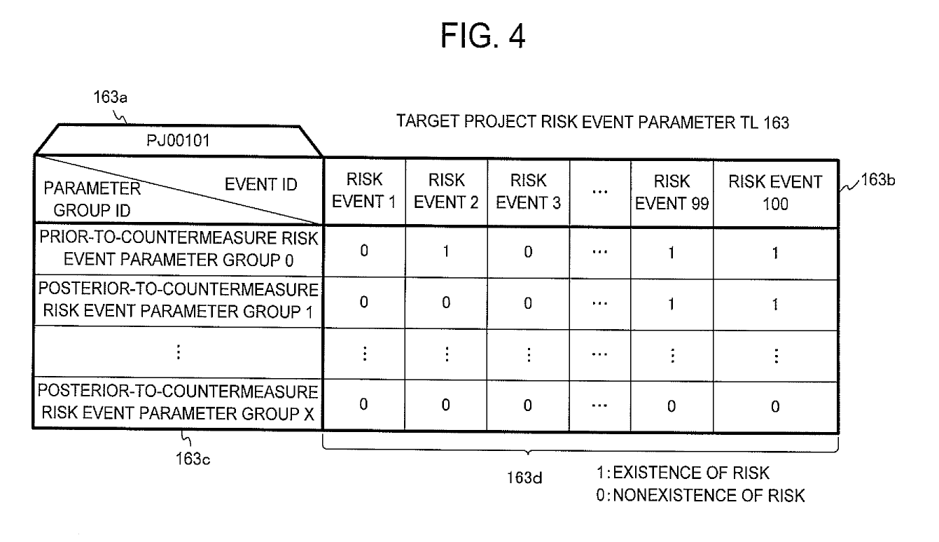

As shown in FIG. 4, the target project risk event parameter table 163 has a project ID area 163a for storing a project ID of the target project, a risk event ID area 163b for storing each of the risk event IDs stored in the risk event content table 161 (FIG. 2), a parameter group ID area 163c for storing an ID of a risk event parameter group i.e. a set of parameters of each of risk events, and a parameter area 163d for storing risk event parameters for each risk event parameter group. The parameter area 163d stores, as a risk event parameter indicating the degree of risk of a risk event, “0” indicating nonexistence of risk or “1” indicating existence of risk. Although, here a risk event parameter can take only two values “0” and “1”, it is possible to arrange that a risk event parameter can take three or more values.

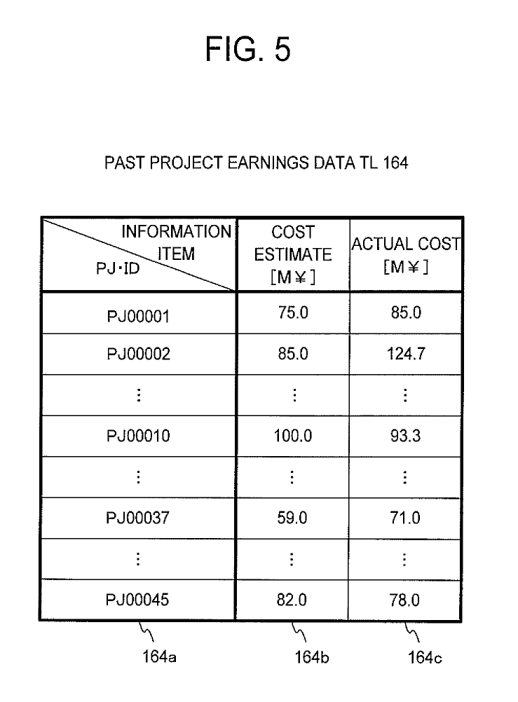

As shown in FIG. 5, the past project earnings data table 164 has a project ID area 164a for storing a project ID of a past project, a cost estimate area 164b for storing a cost estimate of each past project, and an actual cost area 164c for storing an actual cost of each past project.

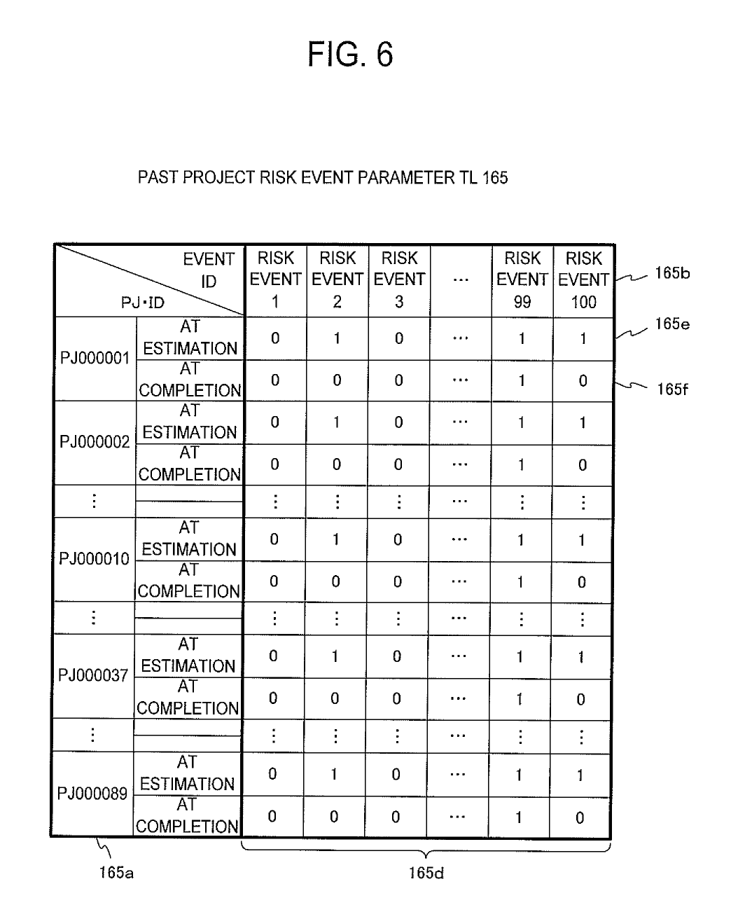

As shown in FIG. 6, the past project risk event parameter table 165 has a project ID area 165a for storing the project IDs of the past projects, a risk event ID area 165b for storing each of the risk event IDs that are stored in the risk event content table 161 (FIG. 2), and a parameter area 165d for storing each of the risk event parameters for each risk event parameter group. The parameter area 165d has a parameter-at-estimation area 165e for storing the risk event parameters at the time of estimating the cost of each past project and a parameter-at-completion area 165f for storing the risk event parameters at the time of completion of a past project.

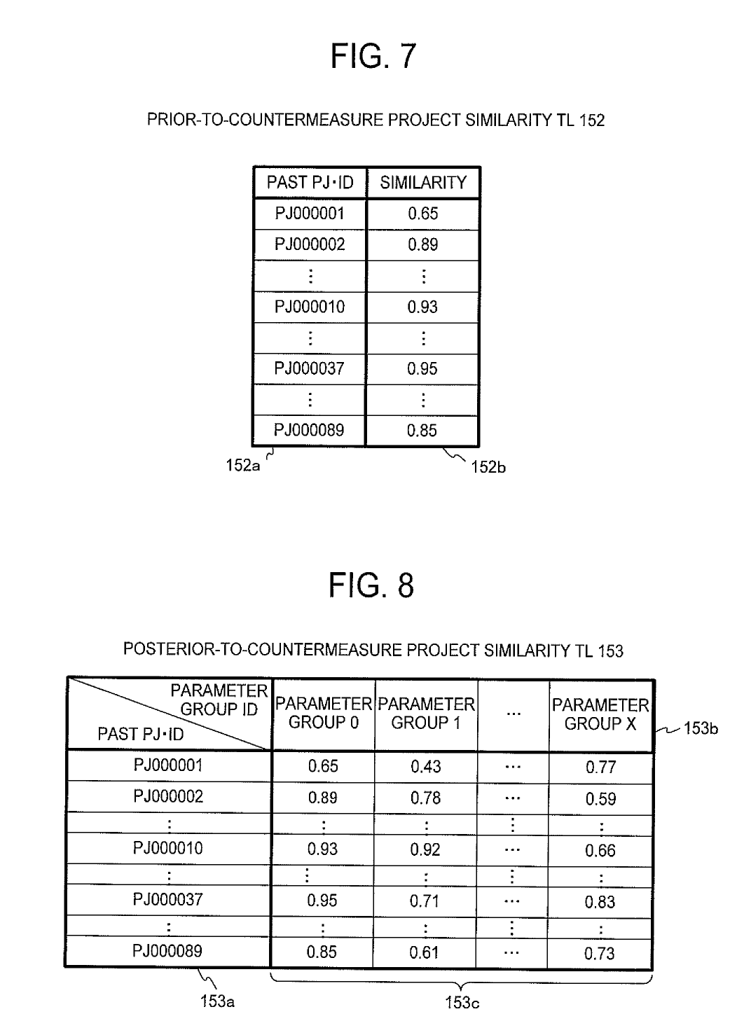

As shown in FIG. 7, the prior-to-countermeasure project similarity table 152 placed in the RAM 150 has a project ID area 152a for storing the project IDs of the past projects, and a similarity area 152b for storing the degrees of similarities between the prior-to-countermeasure risk event parameter group of the target project and the respective risk event parameter groups of the past projects.

As shown in FIG. 8, the posterior-to-countermeasure project similarity table 153 placed in the RAM 150 has a project ID area 153a for storing the project ID of the past projects, a parameter group ID area 153b for storing the risk event parameter group IDs stored in the target project risk event parameter table 163 (FIG. 4), and a similarity area 153c for storing the degrees of similarities between the respective risk event parameter groups of each past project and each of the risk event parameter groups of the target project.

Description will be given referring to FIG. 1 again.

The CPU 110 of the project support apparatus 100 functionally comprises: a receiving part 111 for receiving various data through the input unit 182 and the communication unit; an output part 112 for displaying various data on the display unit 181; a prior-to-countermeasure processing part 120 for generating the earnings fluctuation information prior to taking countermeasures against estimation risks; and a posterior-to-countermeasure processing part 130 for generating the earnings fluctuation information after taking countermeasures against estimation risks.

The prior-to-countermeasure processing part 120 comprises: a similarity calculation part 122 for obtaining the degrees of similarities between the prior-to-countermeasure risk event parameter group and the risk event parameter groups of the plurality of past projects; a project extraction part 123 for extracting IDs of the past projects of the top N highest degrees of similarity; a cost deviation calculation part 124 for obtaining cost deviations with reference to the estimate of the target project, based on the cost estimates and the actual costs of the N past projects; a prior-to-countermeasure fluctuation information generation part 127 for generating prior-to-countermeasure earnings fluctuation information by using these cost deviations; and a processing control part 126 for controlling these functional parts.

Further, the posterior-to-countermeasure processing part 130 comprises: a posterior-to-countermeasure parameter setting part 131 for setting a plurality of posterior-to-countermeasure risk event parameter groups by changing the parameters in the prior-to-countermeasure risk event parameter group; a similarity calculation part 132 for obtaining similarities between one posterior-to-countermeasure risk event parameter group out of the plurality of posterior-to-countermeasure risk event parameter groups and risk event parameter groups of the plurality of past projects; a project extraction part 133 for extracting IDs of the past projects of the top N highest degrees of similarity; a cost deviation calculation part 134 for obtaining cost deviations with reference to the estimate of the target project, based on the cost estimates and the actual costs of the N past projects; a provisional fluctuation information generation part 135 for generating provisional earnings fluctuation information by using the cost deviations; a processing control part 136 for controlling various functional parts, such as controlling the above-mentioned functional parts 132-135 so as to perform the processing on all the posterior-to-countermeasure risk event parameter groups; a posterior-to-countermeasure fluctuation information generation part 137 for generating posterior-to-countermeasure earnings fluctuation information by statistically processing the provisional earnings fluctuation information for each of all the posterior-to-countermeasure risk parameter groups; and a countermeasure-requiring event extraction part 138 for extracting risk event IDs of risk event parameters that are different from the corresponding risk event parameters in a posterior-to-countermeasure risk event parameter group used for generating the posterior-to-countermeasure earnings fluctuation information, among the risk event parameters in the prior-to-countermeasure risk event parameter group.

Here, all of the above-mentioned functional parts of the CPU 110 function when the CPU 110 executes the project support program 139 stored in the external storage 160.

Next, operation of the project support apparatus 100 will be described.

So as to make the project support apparatus 100 output earnings fluctuation information which indicates fluctuation of development-manufacturing cost with reference to an estimate of that cost, it is necessary to input earnings data and estimation risk event parameters of many past projects into the project support apparatus 100 in advance.

Thus, the receiving part 111 of the project support apparatus 100 receives IDs of a plurality of past projects, cost estimates and actual costs of those projects, and risk event parameter groups for each of those projects through the input unit 181, the communication unit or the like. Each of the received risk event parameter groups of the past projects is a set of risk event parameters corresponding respectively to the risk events stored in the risk event content table 161 (FIG. 2). Further, the risk event parameter groups of each past project are a risk event parameter group at the time of cost estimation of that past project and a risk event parameter group at the time of completion of that past project.

Then, the receiving part 111 stores the IDs of the past projects in the project ID area 164a of the past project earnings data table 164 shown in FIG. 5, the estimates of the past projects in the cost estimate area 164b of the table 164, and the actual costs of the past projects in the actual cost area 164c of the table 164. Further, the receiving part 111 stores the IDs of the past projects in the project ID area 165a of the past project risk event parameter table 165 shown in FIG. 6, the respective risk event parameter groups at the times of cost estimation of the past projects in the parameter-at-estimation area 165e of the table 165, and the respective risk event parameter groups at the times of completion of the past projects in the parameter-at-completion area 165f.

When the receiving of the past project earnings data and the estimation risk event parameters ends, it becomes possible for the project support apparatus 100 to receive earnings data or the like of the target project at any time, to generate earnings fluctuation information of the target project. That is to say, it becomes possible that the project support apparatus 100 executes the processing shown in the flowcharts of FIGS. 9-13.

Now, referring to the flowcharts shown in FIGS. 9-13, operation of the project support apparatus 100 will be described.

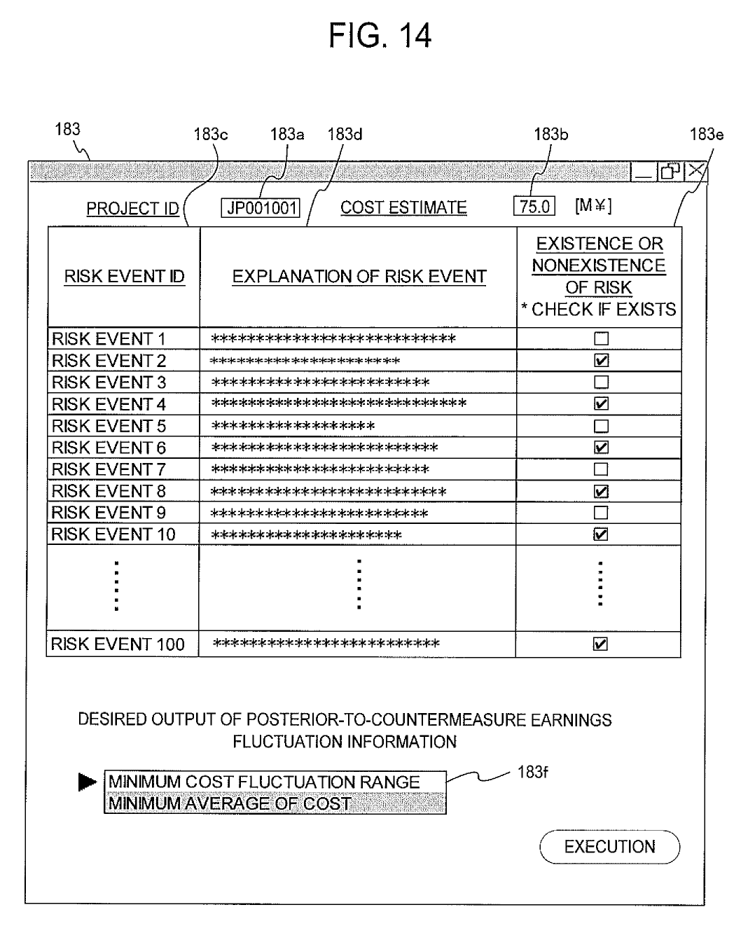

First, as shown in the flowchart of FIG. 9, the receiving part 111 of the project support apparatus 100 receives various data on the target project through the input unit 181 (S10). At that time, the receiving part 111 makes the display unit 182 display the input screen 183 shown in FIG. 14 through the output part 112. The input screen 183 has: a project ID input field 183a into which the project ID of the target project is inputted; a cost estimate input field 183b into which a cost estimate of the target project is inputted; a risk event ID field 183c for displaying the risk event IDs stored in the risk event content table 161 (FIG. 2); a risk event explanation field 183d for displaying respective explanations of the risk event contents corresponding to the risk event IDs; a risk existence-nonexistence check field 183e for checking the existence or nonexistence of risk corresponding to the risk event of the risk event ID concerned; and an output type setting field 183f for setting a desired type of output of the posterior-to-countermeasure earnings fluctuation information.

A user of the project support apparatus 100 sees the input screen 183 and operates the input unit 181 to input the project ID “PJ001001” of the target project in the project ID input field 183 and a cost estimate “75 (75 million)” of the target project in the cost estimate input field 183b. Further, the user refers to the risk event contents displayed in the risk event explanation field 183d, and checks the risk existence-nonexistence check field 183e if there is risk of the risk event concerned. Further, the user selects either “Minimum of cost fluctuation ranges” or “Minimum of average costs” displayed in the output type setting field 183f.

When the user finishes the input and the like of all the input fields 183a, 183b, 183f and the like, he pushes an execution button in the input screen 183. If the execution button should be pushed before the input and the like of all the input fields 183a, 183b, 183f and the like have been finished, the receiving part 111 judges that un-inputted data exists (S11) and prompts input or the like of the un-inputted data. On the other hand, if no un-inputted data exists, the receiving part 111 stores the received input data in the appropriate areas (S20).

In detail, the receiving part 111 stores the project ID “PJ00101” of the target project in the project ID area 162a of the target project earnings data table 162 shown in FIG. 3, and the cost estimate “75” of the target project in the cost estimate area 162b of that table 162. Further, the receiving part 111 stores the project ID “PJ00101” of the target project in the project ID area 163a of the target project risk event parameter table 163 shown in FIG. 4, and, as a parameter group ID, “Prior-to-countermeasure risk event parameter group 0” in the parameter group ID area 163c, and the risk event parameter group “0, 1, 0, . . . , 1, 1” of the target project in the parameter area 163d at the area corresponding to the parameter group ID “Prior-to-countermeasure risk event parameter group 0”. At that time, as for a risk event ID whose risk existence-nonexistence check field 183 is checked, the receiving part 111 treats its parameter as “1 (Existence of risk)”. And, as for a risk event ID whose risk existence-nonexistence check field 183 is not checked, the receiving part 111 treats its parameter as “0 (Nonexistence of risk)”. Further, as for the output type 151 (FIG. 1) set in the output type setting field 183f, the receiving part 111 stores it temporarily in the RAM 150. Here, it is assumed that “Minimum of cost fluctuation ranges” has been set.

Next, the processing control part 126 of the prior-to-countermeasure processing part 120 reads the target project earnings data table 162, the target project risk event parameter table 163, the past project earnings data table 164 and the past project risk event parameter table 165 from the external storage 60, and places these tables in the RAM 150 (S30) in order to make the prior-to-countermeasure processing part 120 execute a prior-to-risk-countermeasure earnings fluctuation information generation process (S40).

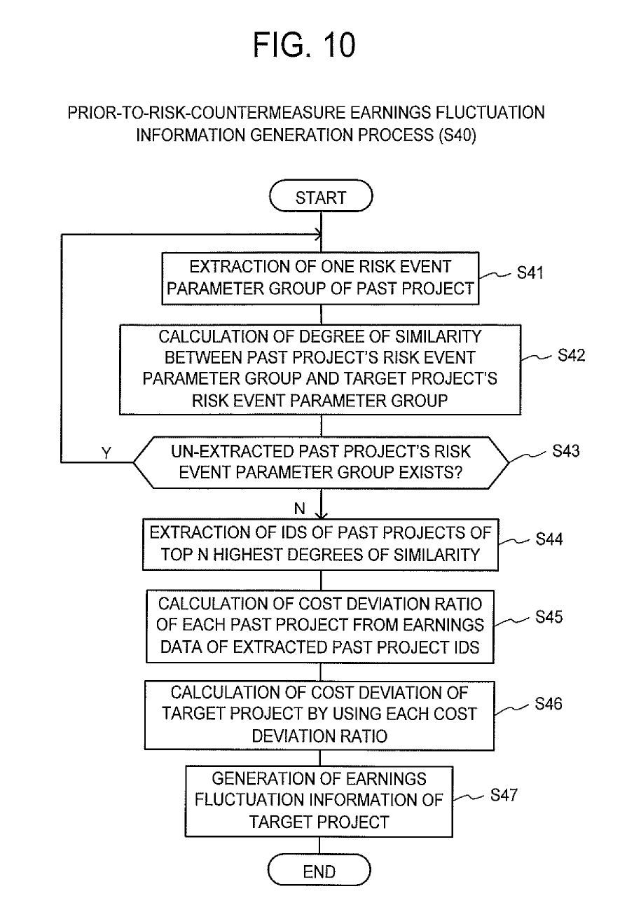

Now, the prior-to-risk-countermeasure earnings fluctuation information generation process (S40) by the prior-to-countermeasure processing part 120 will be described referring to the flowchart shown in FIG. 10.

The similarity calculation part 122 of the prior-to-countermeasure processing part 120 extracts one of the risk event parameter groups at the time of estimation from the past project risk event parameter table 165 placed in the RAM 150 (S41), and calculates its degree of similarity to the risk event parameter group of “prior-to-countermeasure risk event parameter group 0” stored in the target project risk event parameter table 163 (FIG. 4) also placed in the RAM 150. Then, the similarity calculation part 122 prepares the prior-to-countermeasure project similarity table 152 (FIG. 7) in the RAM 150, and stores the past project ID “PJ000001” in the past project ID area 152a of that table 152 and also stores the previously-calculated degree of similarity (S42).

The degree of similarity S may be obtained by the following (Eq. 1) of the simplest collaborative filtering method or by another method such as another collaborative filtering method, a clustering method or the like.

$$\begin{matrix}[ Equation 1 ] & \\ S = 1 - \frac{\sqrt{\sum {( {p}_{a , j} - {p}_{p , j} )}^{2}}}{n} & ( Eq . 1 )\end{matrix}$$

Here,
pₐ_{^{,j}}: the j-th risk event parameter of the target project;
pₚ_{^{,j}}: the j-th risk event parameter of the past project; and
n: the number of the risk event parameters constituting the risk event parameter group

The degree of similarity S obtained by (Eq. 1) is a value of not more than 1 and not less than 0. The value which is closer to 1 is recognized to indicate the higher degree of similarity.

Next, the similarity calculation part 122 judges whether there exists a past project risk event parameter group that has not been extracted (S43), and repeats the processing of the steps S41-S43 until there is no un-extracted risk event parameter group of a past project existed.

When it is found that there is no un-extracted risk event parameter group of a past project, the project extraction part 123 extracts the past project IDs of the top N (for example, four) of the highest degrees of similarity from the prior-to-countermeasure project similarity table 152 (FIG. 7) placed in the RAM 150 (S44). Here, in the example shown in FIG. 7, four IDs “PJ000037 (Similarity 0.95)”, “PJ000010 (0.93)”, “PJ000002 (Similarity 0.89)” and “PJ000045 (Similarity 0.85) are extracted.

Next, the cost deviation calculation part 124 obtains a cost deviation ratio Dr of each of the past projects extracted in the step S44 according to the following (Eq. 2) by using the cost estimate E and the actual cost R corresponding to the ID of the past project concerned (S45).

Dr=(R−E)/E (Eq. 2)

For example, in the case of the past project ID “PJ000010”, the cost estimate E (=100.0) and the actual cost (=93.3) corresponding to that ID “PJ000010” are obtained by referring to the past project earnings data table 164 shown in FIG. 5. Then, these values are substituted into (Eq. 2), to obtain the cost deviation ratio Dr (=−0.067) for that ID “PJ000037”.

Successively, the cost deviation calculation part 124 obtains a cost deviation D of the target project for each of the cost deviation ratios Dr of the N past projects according to the following (Eq. 3) by using the cost deviation ratios Dr of the N past projects and the cost estimate of the target project (S46).

D=E·Dr (Eq. 3)

For example, in the case of the past project ID “PJ000010”, the cost estimate E (=75) of the target project is multiplied by the cost deviation ratio Dr (=−0.067) obtained in the step S45 with respect to the ID “PJ000010”, to obtain the cost deviation D (=−5.0) of the target project.

Next, the prior-to-countermeasure fluctuation information generation part 127 obtains the minimum deviation and the maximum deviation out of the N cost deviations D of the target project. That is to say, the N cost deviations D are statistically processed to obtain the minimum deviation and the maximum deviation. Then, the prior-to-countermeasure fluctuation information generation part 127 adds the minimum deviation to the cost estimate of the target project, and stores the result as the minimum cost in the prior-to-risk-countermeasure minimum cost area 162c of the target project earnings data table 162 (FIG. 3). And the prior-to-countermeasure fluctuation information generation part 127 adds the maximum deviation to the cost estimate of the target project, and stores the result as the maximum cost in the prior-to-risk-countermeasure maximum cost area 162c of the target project earnings data table 162 (FIG. 3) (S47).

For example, in the case where the target project's cost deviations D obtained in the step S46 are “35.0” for the cost deviation ratio Dr of “PJ000002”, “−5.0” for the cost deviation ratio Dr of “PJ000010”, “15.2” for the cost deviation ratio Dr of “PJ000037”, and “−3.7” for the cost deviation ratio Dr of “PJ000045”, the minimum deviation is “−5.0” and the maximum deviation is “35.0”. Thus, the minimum cost of the target project is “70.0 (=75.0−5.0)”, and the maximum cost of the target project is “110.0=750.0+35.0”. These values are stored in the prior-to-risk-countermeasure minimum cost area 162c and the prior-to-risk-countermeasure maximum cost area 162d of the earnings data table 162 (FIG. 3) respectively.

In the present embodiment, the prior-to-risk-countermeasure earnings (cost) fluctuation information is information including the target project's minimum and maximum costs obtained in the step S47 and the cost fluctuation quantity i.e. a difference between the maximum cost and the minimum cost.

This is the end of the prior-to-risk-countermeasure earnings fluctuation information generation process (S40) by the prior-to-countermeasure processing part 120.

Now, description will be given referring to the flowchart shown in FIG. 9 again.

When the prior-to-risk-countermeasure earnings fluctuation information generation process (S40) ends, then the posterior-to-countermeasure processing part 130 generates the posterior-to-risk-countermeasure earnings fluctuation information (S50).

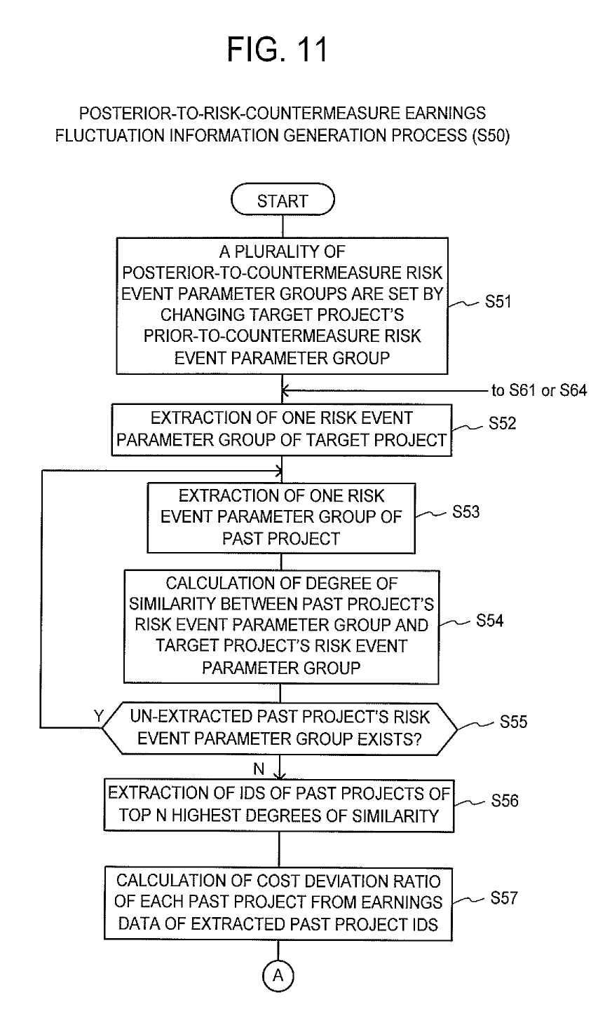

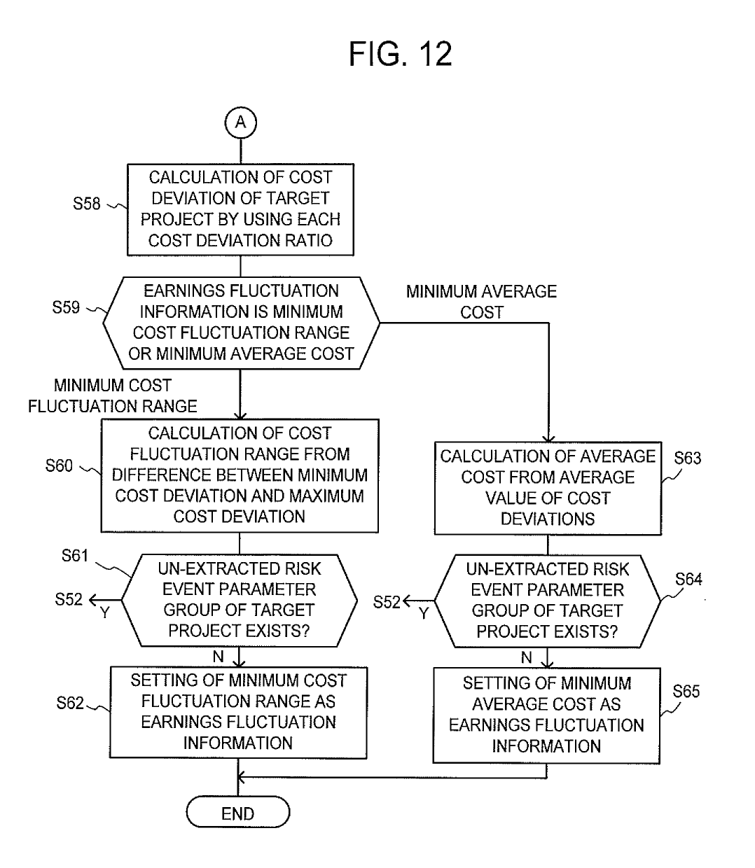

Here, the posterior-to-risk-countermeasure earnings fluctuation information generation process (S50) by the posterior-to-countermeasure processing part 130 will be described referring to the flowchart shown in FIGS. 11 and 12.

The posterior-to-countermeasure parameter setting part 131 of the posterior-to-countermeasure processing part 130 changes a risk event parameter in the risk event parameter group of the target project in order to eliminate the risk in question. Such operation is performed until the risks of all the risk parameters do not exist, and all the posterior-to-counter measure risk event parameter groups obtained are stored in the target project risk event parameter table 163 (FIG. 4) (S51).

In detail, the posterior-to-countermeasure parameter setting part 131 changes the first parameter “1” to “0” among the risk event parameters “0, 1, 0, . . . , 1, 1” of the risk event parameter group of the parameter group ID “Prior-to-countermeasure risk event parameter group 0” in the target project risk event parameter table 163 (FIG. 4), to generate a first posterior-to-countermeasure parameter group “0, 0, 0, . . . , 1, 1”. Then, the posterior-to-countermeasure parameter setting part 131 stores “Posterior-to-countermeasure risk event parameter group 1” in the parameter group ID area 163c of the risk event parameter table 163, and stores the above-mentioned first posterior-to-countermeasure parameter group “0, 0, 0, . . . , 1, 1” in the parameter area 163d at the position associated with that parameter group ID. Next, the posterior-to-countermeasure parameter setting part 131 changes only the next parameter “1” to “0” among the risk event parameter group “0, 1, 0, . . . , 1, 1” of the parameter group ID “Prior-to-countermeasure risk event parameter group 0”, to generate a second posterior-to-countermeasure parameter group “0, 1, 0, . . . , 1, 1”. Then, together with its parameter group ID, the second posterior-to-countermeasure parameter group “0, 1, 0, . . . , 1, 1” is stored in the risk event parameter table 163. In the same way, posterior-to-countermeasure risk event parameter groups are obtained until all the risk event parameters of the risk event parameter group “0, 1, 0, . . . , 1, 1” of the parameter group ID “Prior-to-countermeasure risk event parameter group 0” become “0”, and all the posterior-to-countermeasure risk event parameter groups obtained are stored in the risk event parameter table 163.

Next, the similarity calculation part 132 of the posterior-to-countermeasure processing part 130 extracts a pair of a parameter ID and a risk event parameter group from the target project risk event parameter table 163 (FIG. 4) (S52), and extracts a pair of a parameter ID and a risk event parameter group from the past project risk event parameter table 165 (FIG. 6) (S53). Then, the similarity between the two extracted risk event parameter groups is calculated by using the above-mentioned (Eq. 1), and the obtained similarity is stored in the posterior-to-countermeasure project similarity table 153 shown in FIG. 8 (S54).

Successively, the similarity calculation part 132 judges whether there is an un-extracted past project risk event parameter group (S55). If there is an un-extracted group, the processing returns to the step S53, and otherwise proceeds to the step S56.

Although the processing in the step S52 is performed repeatedly, the target project risk event parameter group extracted for the first time in the processing of the step S52 is the prior-to-countermeasure risk event parameter group. Further, although the processing in the steps S53-S55 is also performed repeatedly, the object of the processing in the steps 53-55 is a risk event parameter group at the time of estimation of a past project until a posterior-to-countermeasure risk event parameter group of the target project is extracted as a new parameter group in the step S52. That is to say, until a posterior-to-countermeasure risk event parameter group of the target project is extracted as a new parameter group in the step S52, the degree of similarity between each of the risk event parameter groups at the times of estimation of all the past projects and the prior-to-countermeasure risk event parameter of the target project is calculated in this repetitive processing of the steps S53-S55. And the calculated degrees of similarity are stored in the posterior-to-countermeasure project similarity table 153 shown in FIG. 8 such that all the degrees of similarity shown in the fields of the column indicating that the parameter group ID is “Parameter group 0 (before taking countermeasure)” in the table 153 are stored with the calculated degrees of similarity. These degrees of similarity in the column of the parameter group ID “Parameter group 0 (before taking countermeasure) are same as the degrees of similarity stored in the prior-to-countermeasure similarity table 152 shown in FIG. 7, respectively.

When it is judged in the step S55 that there is no un-extracted risk event parameter group of a past project, then the project extraction part 133 extracts the past project IDs corresponding to the top N (for example, four) highest degrees of similarity from the posterior-to-countermeasure project similarity table 153 shown in FIG. 8 (S56). Next, the cost deviation calculation part 134 obtains a cost deviation ratio Dr for each past project according to the above-mentioned (Eq. 2) by using the cost estimates E and the actual costs R corresponding to the past project IDs extracted in the step S56 (S57). Successively, the cost deviation calculation part 134 obtains a cost deviation D of the target project for each of the N cost deviation ratios Dr according to the above-mentioned (Eq. 3) by using the N cost deviation ratios Dr and the cost estimate E of the target project (S58 (FIG. 12)).

When the cost deviation D of the target project for each of the N cost deviation ratios Dr is obtained (S58), the processing control part 136 judges which of “Minimum of cost fluctuation ranges” and “Minimum of average costs” is stored as the output type 151 (FIG. 1) in the RAM 150 (S59). If “Minimum of cost fluctuation ranges” is stored as the output type 151, the processing proceeds to the step S60. Otherwise if “Minimum of average costs” is stored, the processing proceeds to the step S63.

In the step S60, the provisional fluctuation information generation part 135 obtains the minimum cost deviation and the maximum cost deviation out of N cost deviations D obtained in the step S58, calculates a difference between the minimum and maximum cost deviations as a cost fluctuation range, and stores in the RAM 150 the obtained cost fluctuation range together with the minimum cost deviation, the maximum cost deviation, and the target project's risk event parameter group ID indicating the minimum cost deviation.

Next, the processing control part 136 judges whether there is an un-extracted risk event parameter group of the target project (S61). If there is an un-extracted risk event parameter, the processing returns to the step S52.

In the step 52, similarly to the above, the similarity calculation part 132 extracts a pair of a parameter ID and a risk event parameter group from the target project risk event parameter table 163 (FIG. 4). Further, the similarity calculation part 132 extracts a pair of a parameter ID and a risk event parameter group from the past project risk event parameter table 165 (FIG. 6) (S53). Then, the similarity between the two extracted risk event parameter groups is calculated by using the above-mentioned (Eq. 1), and the obtained similarity is stored in the posterior-to-countermeasure project similarity table 153 shown in FIG. 8 (S54). Successively, the similarity calculation part 132 judges whether there is an un-extracted past project risk event parameter group (S55). If there is an un-extracted group, the processing returns to the step S53, and otherwise proceeds to the step S56.

Here, a target project's risk event parameter group extracted in the second or later processing in the step S52 is a posterior-to-countermeasure risk event parameter group. Further, in that case, the object in the processing in the steps S53-S55 is a risk event parameter group at the time completion of a past project. That is to say, in this repetitive processing of the steps 53-55, the degree of similarities between each of the risk event parameter groups at the times of completion of all the past projects and the prior-to-countermeasure risk event parameter of the target project is calculated. And the calculated degrees of similarity are stored in the posterior-to-countermeasure project similarity table 153 shown in FIG. 8 such that all the degrees of similarity shown in the fields of one column indicating that a parameter group ID is “Parameter group x (x>=1) (after taking countermeasure)” in the table 153 are stored with the calculated degrees of similarity.

After that, similarly to the above, the steps 56-61 are executed. Thus, until it is judged in the step S61 that there is no un-extracted risk event parameter group of the target project, the processing in the steps S52-S61 is repeated.

When it is judged in the step S61 that there is no un-extracted risk event parameter group of the target project, the posterior-to-countermeasure fluctuation information generation part 137 selects the minimum cost fluctuation range among a plurality of cost fluctuation ranges stored in the RAM 150, as a part of the posterior-to-countermeasure earnings fluctuation information. Successively, the posterior-to-countermeasure fluctuation information generation part 137 refers to the RAM 150 to obtain the minimum cost deviation and the maximum cost deviation corresponding to the minimum cost fluctuation range, these data being stored in the step S60, and adds the cost estimate to these deviations to obtain the posterior-to-countermeasure minimum cost and the posterior-to-countermeasure maximum cost. Then, the posterior-to-countermeasure fluctuation generation part 137 stores the posterior-to-countermeasure minimum cost in the posterior-to-risk-countermeasure minimum cost area 162e of the target project earnings data table 162 (FIG. 3), and the posterior-to-countermeasure maximum cost in the posterior-to-risk-countermeasure maximum cost area 162f (S62), to end the posterior-to-risk-countermeasure earnings fluctuation information generation process (S50). Here, the posterior-to-countermeasure earnings (cost) fluctuation information includes the minimum cost fluctuation range obtained in the step S61 and the minimum cost and the posterior-to-countermeasure maximum cost corresponding to this minimum cost fluctuation range.

If it is judged in the step S59 that as the output type 151 (FIG. 1) “Minimum of average costs” is stored in the RAM 150, the provisional fluctuation information generation part 135 calculates the average value of the N cost deviations D obtained in the step S58, and adds the cost estimate to the calculated average value to obtain an average cost. Then, this average cost is stored in the RAM 150 together with the target project's risk event parameter group ID that shows the cost deviation D closest to the average value of the cost deviations D (S63).

Next, the processing control part 136 judges whether there exists an un-extracted risk event parameter group of the target project (S64). If there is an un-extracted risk event parameter of the target project, the processing returns to the step S52.

When the processing returns to the step S52, one of the posterior-to-countermeasure risk event parameter groups is extracted in this step S52 out of the risk event parameter groups of the target project, similarly to the case where the judgment in the step S61 causes returning to the step S52. And, in the repetitive processing of the steps S53-S55, the degree of similarity between each of the risk event parameter groups at the times of completion of all the past projects and the posterior-to-countermeasure risk event parameter of the target project is calculated. And after that, similarly to the above, the steps S56-S59, S63 and S64 are executed. And, until it is judged in the step S64 that there is no un-extracted risk event parameter group of the target project, the processing of the steps S52-S59, S63 and S64 is repeated.

When it is judged in the step S64 that there is no un-extracted risk event parameter group of the target project, then the posterior-to-countermeasure fluctuation information generation part 137 selects the minimum average cost among a plurality of average costs stored in the RAM 150, to take it as the posterior-to-countermeasure earnings fluctuation information. And, the minimum average cost is stored in the posterior-to-risk-countermeasure minimum average cost area 162g of the target project earnings data table 162 (FIG. 3) (S63), to end the posterior-to-risk countermeasure earnings fluctuation information generation process (S50). However, FIG. 3 shows an example where “Minimum of cost fluctuation ranges” has been selected as the output type 151, and thus the minimum average cost is not stored in the posterior-to-risk-countermeasure minimum average cost area 162g.

Returning again to the flowchart shown in FIG. 9, description will be given.

When the posterior-to-risk-countermeasure earnings fluctuation information generation process (S50) ends, the countermeasure-requiring event extraction part 138 extracts risk event IDs of risk event parameters that are, among the risk event parameters of the prior-to-countermeasure risk event parameter group, different from the corresponding risk event parameters of the posterior-to-countermeasure risk event parameter group used for generating the posterior-to-countermeasure earnings fluctuation information. The extracted risk event IDs are taken as countermeasure-requiring risk event IDs (S70).

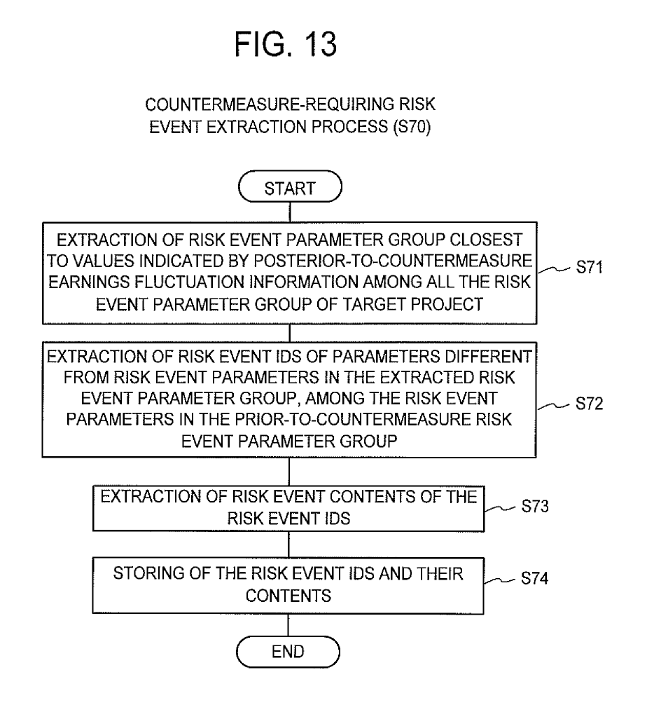

Here, the countermeasure-requiring risk event extraction process (S70) performed by the countermeasure-requiring event extraction part 138 will be described referring to the flowchart shown in FIG. 13.

First, the countermeasure-requiring event extraction part 138 extracts, out of all the risk event parameter groups of the target project, a risk event parameter group that is closest to the values indicated by the posterior-to-countermeasure fluctuation information (S71). Here, in the case where the posterior-to-countermeasure earnings fluctuation information includes the minimum cost fluctuation range after taking the countermeasure, the countermeasure-requiring event extraction part 138 refers to the RAM 150 in which the target project's risk event parameter group ID showing the minimum cost deviation is stored in the step S60 (FIG. 12), to obtain that risk event parameter group ID showing the minimum cost deviation used to obtain the posterior-to-countermeasure minimum cost fluctuation range. Then, the risk event parameter group corresponding to the obtained risk event parameter group ID is extracted from the target project risk event parameter table 163 (FIG. 4). Further, in the case where the posterior-to-countermeasure earnings fluctuation information includes the posterior-to-countermeasure minimum average cost, the countermeasure-requiring event extraction part 138 refers to the RAM 150 in which the ID of the target project's risk event parameter group showing the cost deviation D closest to the average value of the cost deviations D is stored in the step S63, to obtain the target project's risk event parameter group ID showing the cost deviation D closest to the average values of the cost deviations D corresponding to the posterior-to-countermeasure minimum average cost. In this case also, similarly to the above, the risk event parameter group corresponding to the risk event parameter group ID in question is extracted from the target project risk event parameter table 163 (FIG. 4).

Among risk event parameters in the prior-to-countermeasure risk event parameter group, the countermeasure-requiring event extraction part 138 extracts risk event IDs whose parameters are different from the risk event parameters in the risk event parameter group extracted above (S72). Successively, from the risk event content table 161 (FIG. 2), the countermeasure-requiring event extraction part 138 extracts the risk event contents corresponding to the risk event IDs extracted in the step S72 (S73).

Finally, the countermeasure-requiring event extraction part 138 stores the risk event IDs and their contents in the countermeasure-requiring risk event table 166 (FIG. 1), to end the countermeasure-requiring risk event extraction process (S70).

Referring to the flowchart shown in FIG. 9 again, description will be given.

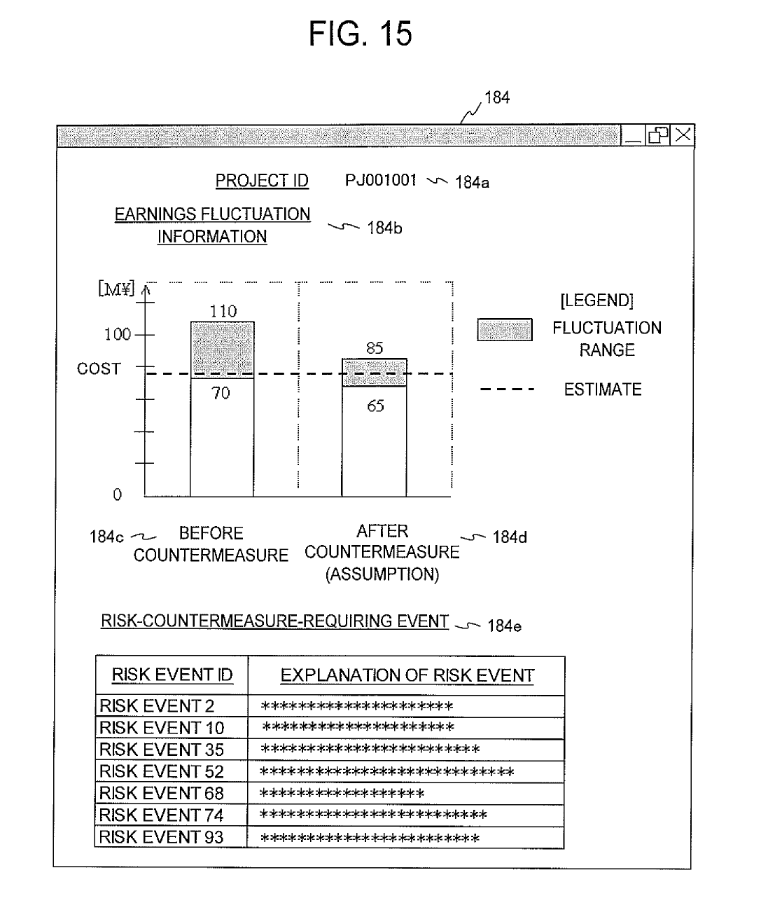

When the countermeasure-requiring risk event extraction process (S70) ends, the output part 112 makes the display unit 182 display the output screen 184 shown in FIG. 15 (S80).

This output screen 184 displays the target project ID 184a, the earnings fluctuation information 184b, and the risk-countermeasure-requiring events 184e.

The earnings fluctuation information 184b is shown by a bar graph whose vertical axis shows cost. This bar graph includes a bar graph 184c that indicates the prior-to-risk-countermeasure earnings fluctuation information and a bar graph 184d that indicates the posterior-to-countermeasure earnings fluctuation information. These bar graphs 184c and 184d each show the minimum and maximum costs concerned. And the color of the part between the minimum cost and the maximum cost is changed from the color of the other part, to indicate the cost fluctuation range also. Further, the cost estimate is shown in each of the bar graphs 184c and 184d.

The risk-countermeasure-requiring events 184e are a set of the risk event IDs and their contents stored in the countermeasure-requiring risk event table 166. As described above, the risk event IDs in the risk-countermeasure-requiring events 184e are the risk event IDs of the risk event parameters that are, among the risk event parameters in the prior-to-countermeasure risk event parameter group, different from the corresponding risk event parameters in the posterior-to-countermeasure risk event parameter group used for generating the posterior-to-countermeasure earnings fluctuation information. Thus, by taking countermeasures against the risk events in the risk-countermeasure-requiring events 184e, it is possible to change the prior-to-risk countermeasure cost into the posterior-to-countermeasure cost.

The present embodiment described hereinabove indicates cost (earning) fluctuation information with reference to a cost estimate regarding a target project, and thus it is possible to support judgment on the advisability of execution of the target project, determination of a budget for the target project, and the like. In addition, the present embodiment indicates not only the cost fluctuation information on the condition that countermeasures against a plurality of estimation risk events are taken, but also the risk events requiring the countermeasures in order to obtain the values indicated by the cost fluctuation information after taking the countermeasures. Thus, it is possible to promote countermeasures against risk events in advancing a project.

In the posterior-to-risk-countermeasure earnings fluctuation information generation process (S50) of the present embodiment, the posterior-to-countermeasure earnings fluctuation information is generated by using the prior-to-countermeasure risk event parameter group included in the risk event parameter groups of the target project. However, it is possible to arrange that posterior-to-countermeasure earnings fluctuation information is generated by using only the posterior-to-countermeasure risk event parameter groups without using the prior-to-countermeasure risk event parameter group.

Further, in the present embodiment, costs of development and manufacturing are employed as the earnings parameters. However the present invention is not limited to this, and sales volume, sales in units, profit and loss, and the like of deliverables of a project may be employed as earnings parameters. In that case, earnings fluctuation information is sales volume fluctuation information, unit sales fluctuation information, and profit-or-loss fluctuation information.

Further, in the present embodiment, the prior-to-risk-countermeasure earnings fluctuation information includes a fluctuation range of earnings (cost), and the minimum and maximum values as the values at both ends of the fluctuation range. And, the posterior-to-risk-countermeasure earnings fluctuation information includes the minimum fluctuation range of earnings, and the minimum and maximum values as the values at both ends of the fluctuation range, and the minimum average value. Needless to say, however, it is possible to support judgment on the advisability of execution of a target project, determination of budget for a target project, or the like only if the earnings fluctuation information includes any one of these values. However, the more types of data the earnings fluctuation information includes, the more useful the earnings fluctuation information is for judgment on the advisability of execution of a target project. Thus, it is favorable that the earnings fluctuation information includes more types of data as far as possible. Further, the prior-to-risk-countermeasure earnings fluctuation information may include, for example, the minimum and maximum deviations with reference to an estimate of earnings, and the posterior-to-risk-countermeasure earnings fluctuation information may include, for example, the maximum minimum deviation or the maximum minimum value, the minimum maximum deviation or the minimum maximum value, the maximum fluctuation range and the minimum and maximum values as values at both ends of the range, average minimum value, or the like concerning earnings.

Here, among the data types that may be included in the posterior-to-risk-countermeasure earnings fluctuation information, the maximum minimum deviation or the maximum minimum value of earnings is obtained as follows. First, the provisional fluctuation information generation part 135 obtains the minimum deviation among earnings parameter's deviations obtained from respective deviation ratios of a plurality of past projects, or obtains the earnings parameter's minimum value determined by that minimum deviation. Then, the posterior-to-countermeasure fluctuation information generation part 137 extracts the maximum value among the minimum deviations or minimum values obtained respectively from all the risk event parameter groups of the target project, and determines that maximum value as the maximum minimum deviation or maximum minimum value concerning the earnings. Further, the minimum maximum deviation or the minimum maximum value of earnings is obtained as follows. First, the provisional fluctuation information generation part 135 obtains the maximum deviation among earnings parameter's deviations obtained from respective deviation ratios of a plurality of past projects, or obtains the earnings parameter's maximum value determined by that maximum deviation. Then, the posterior-to-countermeasure fluctuation information generation part 137 extracts the minimum value among the maximum deviations or maximum values obtained respectively from all the risk event parameter groups of the target project, and determines that minimum value as the minimum maximum deviation or minimum maximum value concerning the earnings.

100: the project support apparatus, 110: the CPU, 111: the receiving part, 112: the output part, 120 the prior-to-countermeasure processing part, 122,132: the similarity calculation part, 123,133: the project extraction part, 124,134: the cost deviation calculation part, 126,136: the processing control part, 127: the prior-to-countermeasure fluctuation information generation part, 130: the posterior-to-countermeasure processing part, 131: the posterior-to-countermeasure parameter setting part, 135: the provisional fluctuation information generation part, 137: the posterior-to-countermeasure fluctuation information generation part, 138: the countermeasure-requiring event extraction part, 140: the ROM, 150: the RAM, 151: the output type, 152: the prior-to-countermeasure project similarity table, 153: the posterior-to-countermeasure project similarity table, 160: the external storage 161: the risk event table, 162: the target project earnings data table, 163: the target project risk event parameter table, 164: the past project earnings data table, 165: the past project risk event parameter table, 166: the countermeasure-requiring risk event table, 169: the project support program, 182: the display unit, 183: the input screen, 184: the output screen

1. A project support apparatus for supporting a target project on a basis of an estimate of an earnings parameter concerning earnings from deliverables of the target project, comprising:
a past data receiving means, which receives an estimate and an actual value of the earnings parameter concerning the earnings from the deliverables of each of a plurality of past project, and a risk event parameter group i.e. a set of risk event parameters indicating respectively degrees of estimation risks of a plurality of estimation risk events of the past project in question;
a target data receiving means, which receives the estimate of the earnings parameter concerning the target project, and a risk event parameter group i.e. a set of risk event parameters indicating respectively degrees of estimation risks of the plurality of estimation risk events concerning the target project;
a similarity calculation means, which obtains, for each of the plurality of past projects, a degree of similarity between the risk event parameter group of the past project in question and the risk event parameter group of the target project;
an extraction means, which extracts, according to previously-determined rule, top one or more past projects having highest degrees of similarities with the target project among the plurality of past projects;
a fluctuation information generation means, which generates earnings fluctuation information concerning fluctuation of the earnings parameter with reference to the estimate of the target project, on a basis of the estimate and actual value of the earnings parameter of each of the one or more past projects extracted by the extraction means; and
an output means, which outputs the earnings fluctuation information.

2. A project support apparatus of claim 1, wherein:
the fluctuation information generation means comprises:
a deviation calculation means, which obtains, on a basis of the estimate and the actual value of the earnings parameter of each of the one or more past projects extracted by the extraction means, a deviation ratio i.e. a ratio of a difference between the estimate and the actual value to the estimate for each of the one or more past project, and multiplies the deviation ratio of each of the one or more past projects by the estimate of the target project, to obtain a deviation of the earnings parameter with reference to the estimate of the target project for each of the deviation ratios of the one or more past projects; and
a generation means, which generates the earnings fluctuation information concerning the fluctuation of the earnings parameter by using the deviation, which is obtained by the deviation calculation means, of the earnings parameter of the target project for each of the one or more past projects' deviation ratios.

3. A project support apparatus of claim 2, wherein:
the earnings fluctuation information includes at least one of: a minimum deviation among the deviations of the earnings parameter of the target project for the respective deviation ratios of the one or more past projects; a minimum value of the earnings parameter, which is obtained from the minimum deviation; a maximum deviation among the deviations; a maximum value of the earnings parameter, which is obtained from the maximum deviation; and a fluctuation range i.e. a difference between the minimum deviation and the maximum deviation.

4. A project support apparatus of claim 1, wherein:
the project support apparatus comprises:
a posterior-to-countermeasure parameter setting means, which changes risk event parameters in the risk event parameter group of the target project in such a direction that degrees of risks become smaller on the assumption of execution of risk countermeasures, to obtain a plurality of posterior-to-countermeasure risk event parameter groups;
a posterior-to-countermeasure similarity calculation means, which obtains, for each of the plurality of past projects, a degree of similarity between a risk event parameter group of the past project in question and one of the posterior-to-countermeasure risk event parameter groups of the target project;
a posterior-to-countermeasure extraction means, which extracts, according to a previously-determined rule, top one or more past projects having highest degrees of similarities with the one of the posterior-to-countermeasure risk parameter groups of the target project among the plurality of past projects;
a provisional fluctuation information generation means, which generates provisional earnings fluctuation information concerning fluctuation of the earnings parameter with reference to the estimate of the target project, on a basis of the estimate and actual value of the earnings parameter of each of the one or more past projects extracted by the posterior-to-countermeasure extraction means;
a processing control means, which causes execution of processing by the posterior-to-countermeasure similarity calculation means, processing by the posterior-to-countermeasure extraction means, and processing by the provisional fluctuation information generation means, with respect to all the posterior-to-countermeasure risk event parameter groups obtained in the posterior-to-countermeasure parameter setting means; and
a posterior-to-countermeasure fluctuation information generation means, which performs statistical processing of the provisional earnings fluctuation information for each of all the posterior-to-countermeasure risk event parameter groups obtained by the posterior-to-countermeasure parameter setting means, to generate posterior-to-countermeasure earnings fluctuation information concerning fluctuation of the earnings parameter with reference to the estimate of the target project; and
the output means outputs the posterior-to-countermeasure earnings fluctuation information.

5. A project support apparatus of claim 4, wherein:
the provisional fluctuation information generation means comprises:
a posterior-to-countermeasure estimation deviation calculation means, which obtains, on a basis of the estimate and the actual value of the earnings parameter of each of the one or more past projects extracted by the posterior-to-countermeasure extraction means, a deviation ratio i.e. a ratio of a difference between the estimate and the actual value to the estimate for each of the one or more past projects, and multiplies the deviation ratio of each of the one or more past projects by the estimate of the target project, to obtain a deviation of the earnings parameter with reference to the estimate of the target project for each of the deviation ratios of the one or more past projects; and
a generation means, which generates the provisional earnings fluctuation information concerning fluctuation of the earnings parameter with reference to the estimate by using the deviation of the earnings parameter of the target project for each of the deviation ratios which are obtained by the posterior-to-countermeasure estimation deviation calculation means of the one or more past projects.

6. A project support apparatus of claim 5, wherein:
the provisional earnings fluctuation information includes at least one of: a minimum deviation among the deviations of the earnings parameter of the target project for the respective deviation ratios of the one or more past projects; a minimum value of the earnings parameter, which is obtained from the minimum deviation; a maximum deviation among the deviations; a maximum value of the earnings parameter, which is obtained from the maximum deviation; a fluctuation range i.e. a difference between the minimum deviation and the maximum deviation; and an average value of the earnings parameter, which is obtained from an average value of the deviations; and
the posterior-to-countermeasure earnings fluctuation information includes:
a maximum minimum deviation among the respective minimum deviations for all the posterior-to-countermeasure risk event parameter groups obtained by the posterior-to-countermeasure parameter setting means, when the provisional earnings fluctuation information includes the minimum deviation;
a maximum minimum value among the respective minimum values for all the posterior-to-countermeasure risk event parameter groups obtained by the posterior-to-countermeasure parameter setting means, when the provisional earnings fluctuation information includes the minimum value of the earnings parameter;
a minimum maximum deviation among the respective maximum deviations for all the posterior-to-countermeasure risk event parameter groups obtained by the posterior-to-countermeasure parameter setting means, when the provisional earnings fluctuation information includes the maximum deviation;
a minimum maximum value among the respective maximum values for all the posterior-to-countermeasure risk event parameter groups obtained by the posterior-to-countermeasure parameter setting means, when the provisional earnings fluctuation information includes the maximum value of the earnings parameter;
a minimum or maximum fluctuation range among the respective fluctuation ranges for all the posterior-to-countermeasure risk event parameter groups obtained by the posterior-to-countermeasure parameter setting means, when the provisional earnings fluctuation information includes the fluctuation range; and
a minimum or maximum average value among the respective average values for all the posterior-to-countermeasure risk event parameter groups obtained by the posterior-to-countermeasure parameter setting means, when the provisional earnings fluctuation information includes the average value.

7. A project support apparatus of claim 4, wherein:
the project support apparatus comprises a countermeasure-requiring event extraction means, which: extracts a posterior-to-countermeasure risk event parameter group that shows a closest value to a value indicated by the posterior-to-countermeasure fluctuation information of the target project, out of all the posterior-to-countermeasure risk event parameter groups obtained by the posterior-to-countermeasure parameter setting means; and extracts, out of the risk event parameters in the target project's risk event parameter group received by the target data receiving step, risk events whose parameters are different from risk event parameters in the posterior-to-countermeasure risk event parameter group; and
the output means, which outputs, as risk-countermeasure-requiring events, the risk events extracted by the countermeasure-requiring event extraction means.

8. A project support program for supporting a target project on a basis of an estimate of an earnings parameter concerning earnings from deliverables of the target project, wherein the project support program makes a computer execute:
a past data receiving step, in which an input means of the computer receives an estimate and an actual value of the earnings parameter concerning the earnings from the deliverables of each of a plurality of past project, and a risk event parameter group i.e. a set of risk event parameters indicating respectively degrees of estimation risks of a plurality of estimation risk events of the past project in question;
a target data receiving step, in which the input means receives the estimate of the earnings parameter concerning the target project, and a risk event parameter group i.e. a set of risk event parameters indicating respectively degrees of estimation risks of the plurality of estimation risk events concerning the target project;
a similarity calculation step, in which, for each of the plurality of past projects, a degree of similarity between the risk event parameter group of the past project in question and the risk event parameter group of the target project is obtained;
an extraction step, in which top one or more past projects having highest degrees of similarities with the target project among the plurality of past projects are extracted according to previously-determined rule;
a fluctuation information generation step, in which earnings fluctuation information concerning fluctuation of the earnings parameter with reference to the estimate of the target project is generated on a basis of the estimate and actual value of the earnings parameter of each of the one or more past projects extracted in the extraction step; and
an information output step, in which an output means of the computer outputs the earnings fluctuation information.

9. A project support program of claim 8, wherein:
in the fluctuation information generation step, the project support program makes the computer execute:
a deviation calculation step, in which, on a basis of the estimate and the actual value of the earnings parameter of each of the one or more past projects extracted in the extraction step, a deviation ratio i.e. a ratio of a difference between the estimate and the actual value to the estimate for each of the one or more past project is obtained, and the deviation ratio of each of the one or more past projects is multiplied by the estimate of the target project, to obtain a deviation of the earnings parameter with reference to the estimate of the target project for each of the deviation ratios of the one or more past projects; and
a generation step, in which the earnings fluctuation information concerning the fluctuation of the earnings parameter is generated by using the deviation (which is obtained in the deviation calculation step) of the earnings parameter of the target project for each of the one or more past projects' deviation ratios.

10. A project support program of claim 8, wherein the project support program makes the computer execute:
a posterior-to-countermeasure parameter setting step, in which risk event parameters in the risk event parameter group of the target project are changed in such a direction that degrees of risks become smaller on the assumption of execution of risk countermeasures, to obtain a plurality of posterior-to-countermeasure risk event parameter groups;
a posterior-to-countermeasure similarity calculation step, in which, for each of the plurality of past projects, a degree of similarity between a risk event parameter group of the past project in question and one of the posterior-to-countermeasure risk event parameter groups of the target project is obtained;
a posterior-to-countermeasure extraction step, in which top one or more past projects having highest degrees of similarities with the one of the posterior-to-countermeasure risk parameter groups of the target project are extracted according to a previously-determined rule, among the plurality of past projects;
a provisional fluctuation information generation step, in which provisional earnings fluctuation information concerning fluctuation of the earnings parameter with reference to the estimate of the target project is generated on a basis of the estimate and actual value of the earnings parameter of each of the one or more past projects extracted in the posterior-to-countermeasure extraction step;
a processing control step, in which the posterior-to-countermeasure similarity calculation step, the posterior-to-countermeasure extraction step, and the provisional fluctuation information generation step are executed with respect to all the posterior-to-countermeasure risk event parameter groups obtained in the posterior-to-countermeasure parameter setting step;
a posterior-to-countermeasure fluctuation information generation step, in which statistical processing of the provisional earnings fluctuation information is performed for each of all the posterior-to-countermeasure risk event parameter groups obtained in the posterior-to-countermeasure parameter setting step, to generate posterior-to-countermeasure earnings fluctuation information concerning fluctuation of the earnings parameter with reference to the estimate of the target project; and
a posterior-to-countermeasure information output step, in which the output means is made to output the posterior-to-countermeasure earnings fluctuation information.

11. A project support program of claim 10, wherein:
in the provisional fluctuation information generation step, the project support program makes the computer execute:
a posterior-to-countermeasure estimation deviation calculation step, in which, on a basis of the estimate and the actual value of the earnings parameter of each of the one or more past projects extracted in the posterior-to-countermeasure extraction step, a deviation ratio i.e. a ratio of a difference between the estimate and the actual value to the estimate for each of the one or more past projects is obtained, and the deviation ratio of each of the one or more past projects is multiplied by the estimate of the target project, to obtain a deviation of the earnings parameter with reference to the estimate of the target project for each of the deviation ratios of the one or more past projects; and
a generation step, in which the provisional earnings fluctuation information concerning fluctuation of the earnings parameter with reference to the estimate is generated by using the deviation of the earnings parameter of the target project for each of the deviation ratios (which are obtained in the posterior-to-countermeasure estimation deviation calculation step) of the one or more past projects.

12. A project support program of claim 10, wherein the project support program makes the computer execute:
a countermeasure-requiring event extraction step, in which:
a posterior-to-countermeasure risk event parameter group that shows a closest value to a value indicated by the posterior-to-countermeasure fluctuation information of the target project is extracted out of all the posterior-to-countermeasure risk event parameter groups obtained in the posterior-to-countermeasure parameter setting step; and, out of the risk event parameters in the target project's risk event parameter group received in the target data receiving step, risk events whose parameters are different from risk event parameters in the posterior-to-countermeasure risk event parameter group are extracted; and
a risk-countermeasure-requiring event output step, in which the risk events extracted in the countermeasure-requiring event extraction means are outputted as risk-countermeasure-requiring events.

13. A project support method for supporting a target project on a basis of an estimate of an earnings parameter concerning earnings from deliverables of the target project, wherein a computer is made to execute:
a past data receiving step, in which an input means of the computer receives an estimate and an actual value of the earnings parameter concerning the earnings from the deliverables of each of a plurality of past project, and a risk event parameter group i.e. a set of risk event parameters indicating respectively degrees of estimation risks of a plurality of estimation risk events of the past project in question;
a target data receiving means, in which the input means receives the estimate of the earnings parameter concerning the target project, and a risk event parameter group i.e. a set of risk event parameters indicating respectively degrees of estimation risks of the plurality of estimation risk events concerning the target project;
a similarity calculation step, in which, for each of the plurality of past projects, a degree of similarity between the risk event parameter group of the past project in question and the risk event parameter group of the target project is obtained;
an extraction step, in which top one or more past projects having highest degrees of similarities with the target project among the plurality of past projects are extracted according to previously-determined rule;
a fluctuation information generation step, in which earnings fluctuation information concerning fluctuation of the earnings parameter with reference to the estimate of the target project is generated on a basis of the estimate and actual value of the earnings parameter of each of the one or more past projects extracted in the extraction step; and
an information output step, in which an output means of the computer outputs the earnings fluctuation information.
